(19) United States
(12) Patent Application Publication
(10) Pub. No.: US 2008/0019024 A1
(43) Pub. Date: Jan. 24, 2008

(54) Multi-Focus Magnifying Glass

(75) Inventor: Cheol Seok Lee, Seoul (KR)

Correspondence Address: HARNESS, DICKEY & PIERCE, P.L.C., P.O. BOX 828, BLOOMFIELD HILLS, MI, 48303, US

(73) Assignee: SIRIS-K CORPORATION, Gongdo-up, Anseong-si (KR)

(21) Appl. No.: 11/791,158

(22) PCT Filed: Nov. 17, 2005
(86) PCT No.: PCT/KR05/03898

§ 371 Date: May 18, 2007

(30) Foreign Application Priority Data
Nov. 19, 2004 (KR) 10-2004-0095152

(51) Int. Cl. G02B 27/02

(52) U.S. Cl. 359/802

(57) ABSTRACT

A multi-focus magnifying glass is disclosed. The multi-focus magnifying glass includes a base plate placed on a supporting surface, a support fixed to the base plate and extended upward, and a lens connected to the end of the support and having a diopter gradually increased from a side thereof to the opposite side thereof so that a user can see magnified letters appearing in the upper and lower sides thereof in an approximately similar size without distortion of images even when magnifying an obliquely inclined (about 45 degrees) book or newspaper placed on a table.

### TECHNICAL FIELD

The present invention relates to a multi-focus magnifying glass, and more particularly, to a multi-focus magnifying glass including a base plate placed on a supporting surface, a support fixed on the base plate and extended from the base plate upward, and a lens having diopter being gradually increased from a side to the opposite side, and allowing a user to see magnified letters appearing in the upper and lower sides thereof in an approximately similar size without distortion of images even when magnifying an obliquely inclined (about 45 degrees) book or newspaper placed on a table.

### BACKGROUND ART

Korean Registered Utility Model No. 20-34082 (Application No. 20-2001-8398: Cited Document No. 1) discloses a magnifying glass of a desk lamp, and Korean Registered Utility Model No. 20-294040 (Application No. 20-2002-11762: Cited Document No. 2) discloses a bellows type magnifier.

### DISCLOSURE OF INVENTION

### TECHNICAL PROBLEM

However, the above-described conventional magnifying glasses are single vision lenses and have a disadvantage that an image is distorted unless being positioned parallel to an object. In other words, when the object (for example, a book) is put on a table and a lens is inclined at 45 degrees with respect to the table so as to see the book, letters appearing in the upper side of the lens appear large because this region of the lens is relatively far from the object and letters appearing in the lower side of the lens appear small because this region of the lens is relatively close to the object.

### TECHNICAL SOLUTION

Therefore, the present invention has been made in view of the above problems and of improving the related devices filed by this applicant of the present invention and their efficiency, and it is an object of the present invention to provide a multi-focus magnifying glass in which a lens having a lower diopter at the upper side thereof being gradually increased from the upper side to the lower side is placed such that a user can see magnified letters appearing in the upper and lower sides thereof in an approximately similar size without distortion of images even when magnifying an obliquely inclined (about 45 degrees) book or newspaper placed on a table.

### ADVANTAGEOUS EFFECTS

As described above, according to the multi-focus magnifying glass of the present invention, magnified letters appearing in the upper and lower sides thereof can be seen in an approximately similar size without distortion of images even when magnifying an obliquely inclined (about 45 degrees) book or newspaper placed on a table.

Moreover, the multi-focus magnifying glass can be folded so that it is convenient to carry.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a single body type multi-focus magnifying glass according to a preferred embodiment of the present invention; and

FIG. 2 is a perspective view illustrating a folding type multi-focus magnifying glass according another preferred embodiment of the present invention.

### Description of Reference Numerals for Main Components of the Drawings

10: base plate 20: support

22: connection device 30: lens

32: diopter mark 34: boundary between diopters

40: hinge 50: light emitting device

### BEST MODE FOR CARRYING OUT THE INVENTION

Hereinafter, preferred embodiments of the present invention will be described in detail. However, the preferred embodiments will be described for the illustrative purpose, but do not limit the spirit and scope of the present invention.

### Embodiment 1

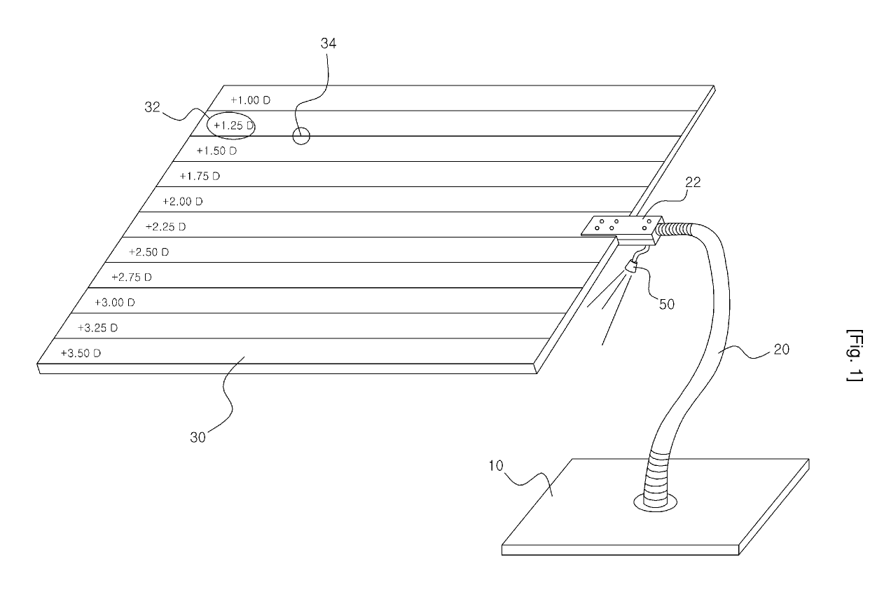

FIG. 1 is a perspective view illustrating a single body type multi-focus magnifying glass according to a preferred embodiment of the present invention.

As shown in FIG. 1, a base plate 10 is placed on a supporting surface such as a desk, a table, or the like. Preferably, the base plate 10 has a weight sufficient to support weight of a lens 30.

At the center of the base plate 10, the lower end of the support 20 is fixed. The support 20 is a kind of a flexible tube, and in the drawing, symbols indicating a flexible tube are omitted from the intermediate portion of the support 20.

In the upper end of the support 20, a connector 22 is attached.

The lens 30 is fixed to the connector 22. Any kind of connector capable of connecting the support 20 to the lens 30 can be used as the connector 22.

In the connector 22, a light-emitting device 50 is attached. The light-emitting device 50 is to be used when it is dark or an object, letters, pictures, or the like cannot be seen well even though they are magnified by the lens 30. In the connector 22, or in the base plate 10, a switch may be installed to turn the light-emitting device 50 on or off.

The lens 30 has a rectangular shape with long transverse sides. The multi-focus magnifying glass is designed to be unfolded on the table and used to read a bible, a book, and chits for receiving and paying money in a bank, and has preferably long sides in the transverse direction, otherwise, and a lens having vertically long sides may be used to read petitions in a civil affairs office of a government office.

When the lens 30 maintains an angle of about 30 to 60 degrees with respect to the table to read a book or a bible on the table, it is the best for eyes.

The lens 30 is designed to have long traverse sides partitioned in the vertical direction and the partitioned parts respectively have a diopter different from each other. Diopter marks 32 are not actually marked on the lens 30, but are depicted in the drawing only for illustrative purposes. The diopter of the partitioned part has a value of +1.00 at the uppermost region of the lens 30 and the value of diopter of the adjacent partitioned lens 30 has a diopter of +1.25, and the value of diopter is successively increased for regions further down the lens. As such, since the value of diopter is successively increased for regions further down the lens, letters of the book opened on the table, appearing at the upper side and the lower side of the lens 30, appear approximately similar in size.

The sizes of letters change according to the position of eyes, therefore the angle of the lens 30 can be adjusted such that the sizes of letters appearing at the upper and lower sides of the lens 30 are approximately similar.

Boundaries 34 between diopters indicate that a diopter of a partitioned part above the boundary 34 is different from diopter of another partitioned part below the boundary 34. The boundaries 34 are marked only for illustrative purposes in the drawing, but do not actually appear on the lens 30.

The lens 30 is gradually thinner from the lower side to the upper side, because the lens 30 can be thin when the diopter is small.

If necessary, the upper side of the lens 30 may have the same thickness as the thickness of the lower side of the lens 30.

As the lens 30, a polycarbonate lens is used. The polycarbonate lens provides a more superior than a usual lens in view of impact resistance, heat resistance, weathering, self-extinguishing, and transparency, and particularly, can endure an impact more than 150 times stronger than conventional tempered glass can endure. Thus, since it is extremely difficult to break the lens 30 by an external impact (even when being run over by a vehicle), the thickness of the lens 30 can be 2 to 5 mm. And since the lens 30 has one third of the weight of conventional tempered glass, the lens 30 is lighter than the conventional tempered glass even when the size thereof is 250 mm×150 mm.

As such, since the polycarbonate lens 30 is light, the base plate 10 can be reduced in size, and the flexible tube type support 20 can be used to support the lens 30.

Various modifications of the support 20 and the base plate 10 can be achieved. For example, the support disclosed in the cited document No. 1 can be used, and/or the tong-like support disclosed in the cited document No. 2 can be used. Otherwise, it is possible to apply a modification whereby connectors are connected to the lateral sides of the lens 30, supports are connected to the connectors in the vertical direction, and a base plate is placed under the supports.

Since the polycarbonate lens is used as the lens 30, the lens 30 can be very thin. Thus, since the lens 30 may injure a user's hand or skin because of a thin rim, the rim of the lens 30 is preferably rounded. If necessary, a protector for protecting the rim of the lens 30 may be attached to the rim. For example, comers and/or rim of the lens 30 may be covered with silicon.

### Embodiment 2

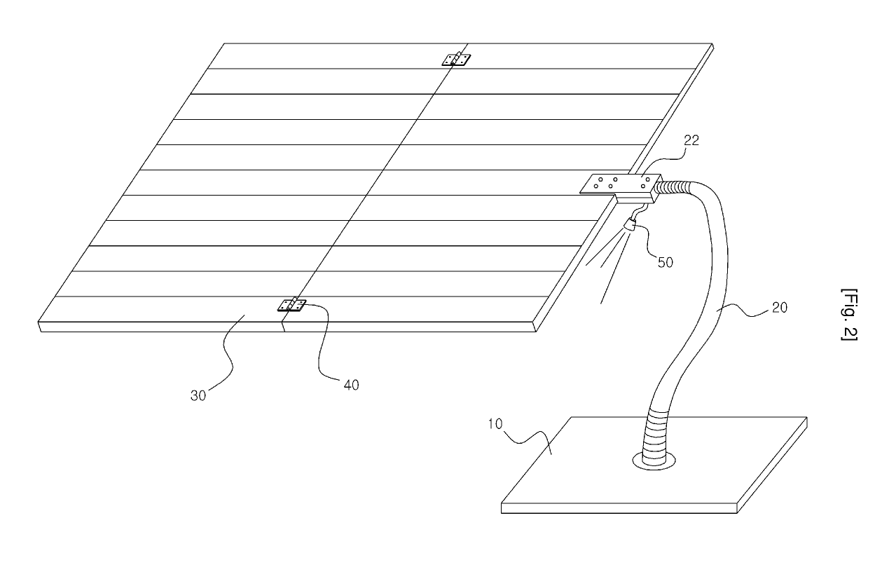

FIG. 2 is a perspective view illustrating a folding type multi-focus magnifying glass according another preferred embodiment of the present invention.

As shown in FIG. 2, the lens 30 is separated into two plates and is identical to the lens 30 depicted in FIG. 1, except for the connection of the two separate plates by hinges 40.

The hinges 40 are installed to the right-sided and left-sided plates of the lens 30 to be connected to each other. The hinges 40 are installed on the upper side of the lens 30 to maintain the lens 30 parallel even when a downward force due to gravity is applied to the left side plate of the lens.

The hinges 40 are preferably made of transparent material with a high rigidity.

If necessary, it is possible to install the hinges 40 not on the upper side of the lens 30, but the lateral sides of the lens 30 to connect the right and left sided plates of the lens 30 to each other.

When the hinges 40 are installed on the lateral sides of the lens 30 and the protector such as silicon is attached to the lateral sides of the lens 30, the hinges 40 can be hidden.

The hinges 40 can be substituted by other various connectors.

It would be understood that the hinges 40 of the present invention do not mean a conventional hinge, but a connecting device for connecting the right and left sided plates of the lens 30 to each other and for folding the lens 30.

The lens 30 can be folded, and the support 20 and the base plate 10 can be separated from the lens 30 so that the multi-focus magnifying glass can be reduced in volume when being packaged.

### MODE FOR THE INVENTION

In accordance with an aspect of the present invention, the above and other objects can be accomplished by the provision of a multi-focus magnifying glass including a base plate placed on a supporting surface, a support fixed to the base plate and extended upward, and a lens connected to the end of the support and having a diopter gradually increased from a side thereof to the opposite side thereof. Preferably, the lens includes an aspherical lens.

Preferably, the lens has a rectangular shape, the upper side of the lens has a low diopter, and the lower side of the lens has a high diopter.

The lens is structured such that two lenses are connected to each other by a hinge to be folded.

Moreover, the multi-focus magnifying glass further includes a light-emitting device attached to the end of the support.

### INDUSTRIAL APPLICABILITY

As described above, the multi-focus magnifying glass according to the present invention can be provided in a place such as a civil affairs office of a government office where a magnifier is provided such that those who apply a petition can use the same.

1. A multi-focus magnifying glass comprising:
a base plate placed on a supporting surface;
a support fixed to the base plate and extended upward; and
a lens connected to the end of the support and having a diopter gradually increased from a side thereof to the opposite side thereof.

2. The multi-focus magnifying glass as set forth in claim 1, wherein the lens has a rectangular shape, the upper side of the lens has a low diopter, and the lower side of the lens has a high diopter.

3. The multi-focus magnifying glass as set forth in claims 1 or 2, wherein the lens is structured such that two lenses are connected to each other by a hinge to be folded.

4. The multi-focus magnifying glass as set forth in claims 1 or 2, further comprising a light-emitting device attached to the end of the support.

5. The multi-focus magnifying glass as set forth in claim 3, further comprising a light-emitting device attached to the end of the support.
